(19) United States
(12) Patent Application Publication
(10) Pub. No.: US 2006/0018503 A1
(43) Pub. Date: Jan. 26, 2006

(54) Speaker device, magnetic circuit for use in speaker device, and method of manufacturing magnetic circuit

(76) Inventor: Nobuhiro Endo, Yamagata-ken (JP)

Correspondence Address: ARENT FOX PLLC, 1050 CONNECTICUT AVENUE, N.W., SUITE 400, WASHINGTON, DC, 20036, US

(21) Appl. No.: 11/185,977

(22) Filed: Jul. 21, 2005

(30) Foreign Application Priority Data
Jul. 22, 2004 (JP) JP 2004-214275

(51) Int. Cl. H04R 25/00

(52) U.S. Cl. 381/412

(57) ABSTRACT

It is an object of the present invention to provide an improved speaker device which can reduce parts-cost by simplifying a cutting treatment for processing yoke and center pole, ensure an easy operation of installing short rings and an extremely simple assembling. The speaker device has a center pole on the center of a yoke. The center pole includes a center pole lower portion integrally formed with the yoke, a disc-like member mounted on the center pole lower portion, and a short ring attached to the surface of the center pole lower portion.

### BACKGROUND OF THE INVENTION

The present invention relates to speaker devices, magnetic circuits for use in the speaker devices, and methods of manufacturing the magnetic circuits.

The present application claims priority from Japanese Application No. 2004-214275, the disclosure of which is incorporated herein by reference.

FIG. 1 is a cross sectional view showing part of a speaker device 1 equipped with a commonly used magnetic circuit of an external magnetic type. The magnetic circuit of such speaker device 1 is comprises a center pole 3, a yoke 2 formed with the center pole 3 in its center, a magnet 4 arranged along the perimeter of the yoke 2, and a plate 5 disposed on the magnet 4. Further, an annular magnetic gap 6 having a predetermined interval is formed between the inner edge of the plate 5 and the outer periphery of the center pole 3, while a voice coil bobbin 8 having a voice coil 7 is arranged within the magnetic gap 6.

However, the speaker device 1 is usually formed such that the shape of the upper half of its magnetic circuit above the plate 5 is different from that of the lower half below the plate 5, or that an AC magnetic flux component generated from the voice coil 7 affects a DC magnetic flux of the magnetic circuit. Consequently, it is impossible to obtain a symmetry in the magnetic flux distribution in the vertical direction of the magnetic gap 6, hence resulting in a distortion in the output of the speaker device.

In order to eliminate an AC magnetic flux component which is partially responsible for the forgoing distortion, it has been considered to dispose a short ring member consisting of a non-magnetic material on the inner side of the magnet 4 separated from the center pole 3, so as to cancel the generated AC magnetic flux and thus alleviate an undesired influence on the DC magnetic flux. On the other hand, when the short ring member is disposed on the inner side of the magnet 4, the inner diameter of the magnet has to be enlarged in order to effectively remove the AC magnetic flux. As a result, using a magnet having a larger diameter or a large thickness will increase the cost and the weight of a speaker device itself.

In order to solve the problem mentioned above, Japanese Patent No. 3003397 has suggested that short rings S₁ and S₂ be attached to the surfaces of the upper and lower portions of the center pole 3, with an annular projection 3A (facing a magnetic gap 6) of the center pole 3 serving as a boundary.

However, an invention disclosed in the forgoing patent document, as shown in FIG. 1, involves the center pole 3 having a complex shape including many convex and concave portions and such center pole 3 is integrally formed with the disc-like yoke 2. Consequently, it is difficult to attach the short rings S1 and S2, especially difficult to attach the short ring S1 to a bent portion between the center pole 3 and the yoke 2, thus resulting in a complicated manufacturing process. Moreover, since the center pole 3 including the yoke 2 has an extremely complex shape, it is difficult to perform a cutting process on them, thus increasing the manufacturing cost.

### SUMMARY OF THE INVENTION

The present invention has been accomplished in order to solve the above-discussed problem and it is an object of the invention to provide an improvement to a speaker magnetic circuit in which short rings made of non-magnetic material are provided on an outer periphery surface of a center pole located inside a voice coil, thereby eliminating an undesired influence of an AC magnetic flux caused by a vibration of the voice coil. In more detail, the present invention is to reduce the steps of a cutting process by simplifying the shapes of yoke and center pole, so as to simplify an operation of installing short rings, thereby reducing the cost of parts, the cost of processing and the cost of assembling.

To achieve the foregoing objects, speaker devices, magnetic circuits for use in the speaker devices, and methods of manufacturing the magnetic circuits, according to the present invention, have at least the following features in the following aspects.

According to one aspect of the present invention, there is provided a magnetic circuit for use in a speaker, which magnetic circuit comprises: a center pole; a yoke on the center of which the center pole is formed; a magnet disposed on the yoke close to the perimeter thereof; a plate disposed on the magnet; a magnetic gap formed between the inner edge of the plate and the outer periphery of the center pole for receiving a voice coil. In particular, the center pole is formed by mounting an independent disc-like member having a diameter larger than that of a center pole lower portion on the center pole lower portion integrally formed with the yoke. Specifically, the magnetic gap is formed by virtue of the periphery surface of the disc-like member, while a non-magnetic short ring is attached to the surface of the center pole lower portion.

According to another aspect of the present invention, there is provided another magnetic circuit for use in a speaker, which magnetic circuit comprises: a center pole; a yoke on the center of which the center pole is formed; a magnet disposed on the yoke close to the perimeter thereof; a plate disposed on the magnet; a magnetic gap formed between the inner edge of the plate and the outer periphery of the center pole for receiving a voice coil. In particular, the center pole is formed by mounting the center pole lower portion not integrally formed with the yoke on the yoke, and including a protruding portion integrally formed with the center pole lower portion and having a diameter larger than that of the center pole lower portion. Specifically, the magnetic gap is formed by virtue of the periphery surface of the protruding portion, while a non-magnetic short ring is attached to the surface of the center pole lower portion.

According to a further aspect of the present invention, there is provided a method of manufacturing a speaker magnetic circuit including: a center pole; a yoke on the center of which the center pole is formed; a magnet disposed on the yoke close to the perimeter thereof; a plate disposed on the magnet; a magnetic gap formed between the inner edge of the plate and the outer periphery of the center pole for receiving a voice coil. In this method, after a non-magnetic short ring is attached to the surface of a center pole lower portion integrally formed with the yoke, a disc-like member having a diameter larger than that of the center pole lower portion is mounted on the center pole lower portion, thereby forming the center pole by virtue of the center pole lower portion and the disc-like member, and thus forming the magnetic gap by virtue of the periphery surface of the disc-like member.

According to one more aspect of the present invention, there is provided another method of manufacturing a speaker magnetic circuit including: a center pole; a yoke on the center of which the center pole is formed; a magnet disposed on the yoke close to the perimeter thereof a plate disposed on the magnet; a magnetic gap formed between the inner edge of the plate and the outer periphery of the center pole for receiving a voice coil. In this method, the center pole is formed by including a center pole lower portion and a protruding portion having a diameter larger than that of the center pole lower portion and integrally formed with the center pole lower portion. Specifically, after a non-magnetic short ring is attached to the surface of the center pole lower portion, the center pole is mounted on the yoke which is not integrally formed with the center pole, and the magnetic gap is formed by virtue of the periphery surface of the protruding portion.

### BRIEF DESCRIPTION OF THE DRAWINGS

These and other objects and advantages of the present invention will become clear from the following description with reference to the accompanying drawings, wherein:

FIG. 1 is a cross sectional view showing part of a conventional speaker device;

FIGS. 2A and 2B are cross sectional views showing part of speaker devices (each having a center pole of two-piece structure) according to a first embodiment of the present invention;

FIGS. 3A and 3B are cross sectional views showing part of speaker devices (each having a center pole of two-piece structure) according to a second embodiment of the present invention; and

FIGS. 4A and 4B are cross sectional views showing part of speaker devices (each having a center pole of three-piece structure) according to a third embodiment of the present invention.

### DETAILED DESCRIPTION OF THE PREFERRED EMBODIMENTS

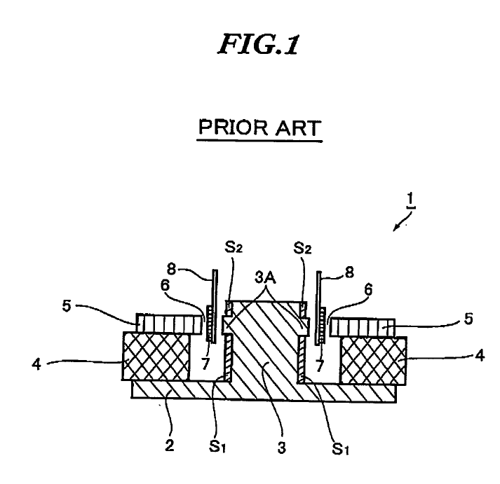

In the following, speaker devices, magnetic circuits for use in the speaker devices, and methods of manufacturing the magnetic circuits, according to the present invention, will be described in detail with reference to the accompanying drawings. However, in embodiments to be described in the following, elements and members which are the same as those of the prior art shown in FIG. 1 will be represented by the same reference numerals and the same explanations will be omitted.

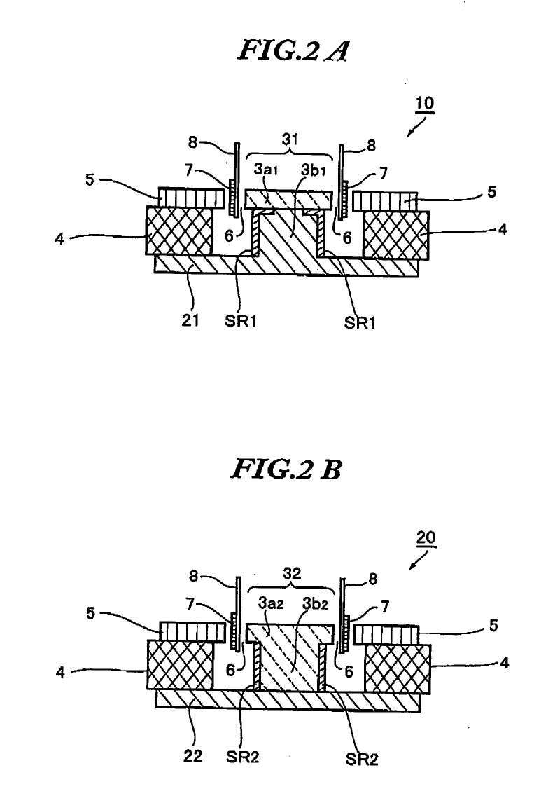

FIGS. 2A and 2B are cross sectional views partially showing speaker devices 10 and 20 formed according to a first embodiment of the present invention. As shown, the magnetic circuits of the speaker devices 10 and 20 shown in the drawings are formed such that center poles 31 and 32 including yokes 21 and 22 are each composed of two pieces of members (two parts), which will be described successively as follows.

The magnetic circuit of the speaker device 10 shown in FIG. 2A is such that the center pole 31 is formed by mounting an independent disc-like member 3a1 having a diameter larger than that of the lower portion 3b1 of the center pole 31 on the lower portion 3b1 of the center pole 31 which is integrally formed with the yoke 21, while a magnetic gap 6 is formed between the outer periphery surface of the disc-like member 3a1 and the inner edge of the plate 5. The disc-like member 3a1 having a diameter larger than that of the lower portion 3b1 of the center pole 31 has almost the same thickness as that of the plate 5 approaching the disc-like member 3a1 through the magnetic gap 6.

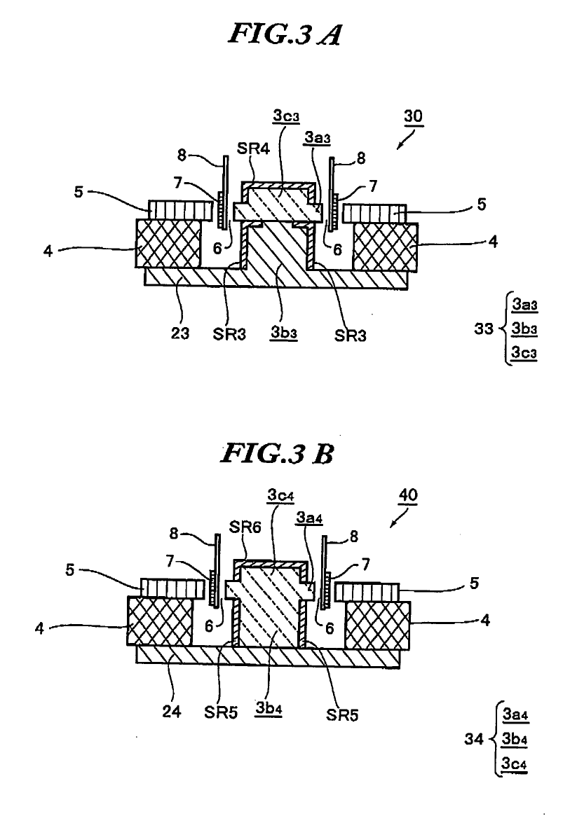

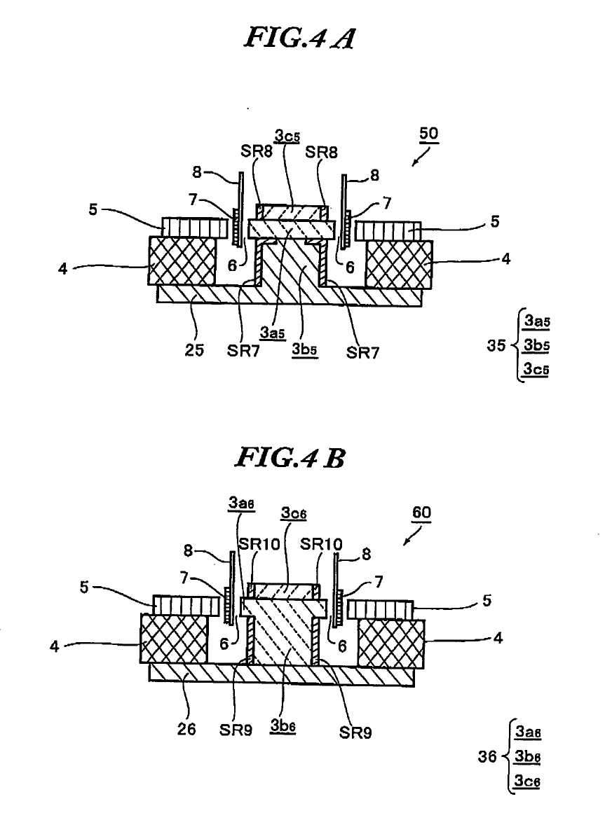

A short ring SR1 is attached to the surface of the lower portion 3b₁ of the center pole 31, and if necessary, can be attached in a manner such that it is connected to the top surface of the lower portion 3b₂ of the center pole 31. At this time, the short ring SR1 has a positioning end portion which is in contact with the top surface of the lower portion 3b₁ of the center pole 31. In this way, it is possible for the short ring SR1 to be exactly attached to a desired position of the lower portion 3b₁ of the center pole 31. Similarly, short rings SR3 and SR7 shown in FIG. 3A and FIG. 4A have the same effects.

According to the present embodiment, when the center pole 31 of the speaker device 10 is assembled, the non-magnetic short ring SR1 is attached to the surface of the lower portion 3b₁ of the center pole 31 which is integrally formed with the yoke 21. Subsequently, a disc-like member 3a₁ having a larger diameter than that of the lower portion 3b₁ of the center pole 31 is mounted on the lower portion 3b₁, thereby obtaining the center pole 31 shown in FIG. 2A. Afterwards, a voice coil bobbin 8 carrying a voice coil 7 is disposed in a magnetic gap 6 formed between the periphery of the disc-like member 3a₁ and the inner edge of the top plate 5.

In this manner, the lower portion 3b₁ of the center pole 31 integrally formed with the yoke 21 has a relatively simple configuration, and the disc-like member 3a₁ also has a simple configuration such that its thickness is almost the same as that of the plate 5. Therefore, the center pole 31 of the speaker device 10 of the present embodiment is a combination of two parts each having a simple configuration, thereby simplifying a cutting process and an operation of installing the short ring SR1.

Next, description will be given to explain a magnetic circuit of a speaker device 20 shown in FIG. 2B. As shown, the speaker device 20 is such that a yoke 22 and a center pole 32 are completely separated from each other before being assembled together. Here, the center pole 32 is formed by mounting a center pole lower portion 3b₂ on the yoke 22 which is not integrally formed with the center pole, and includes a protruding portion 3a₂ integrally formed with the enter pole lower portion 3b₂ and having a diameter larger than that of the center pole lower portion 3b₂. Meanwhile, a magnetic gap 6 is formed between the outer periphery surface of the protruding portion 3a₂ and the inner edge of the plate 5, while a short ring SR2 is attached to the surface of the center pole lower portion 3b₂.

In the present embodiment, FIG. 2B shows that the yoke 22 and the center pole 32 are not integrally formed with each other. When the yoke 22 and the center pole 32 are assembled together, a non-magnetic short ring SR2 is attached to the surface of the center pole lower portion 3b₂, and then bonded to the center of the disc-like yoke 22 which is not integrally formed with the center pole 32, thereby obtaining the center pole 32 shown in FIG. 2B. Subsequently, a voice-coil bobbin 8 is disposed within the magnetic gap 6 formed between the outer periphery surface of the protruding portion 3a₂ and the inner edge of the plate 5, thus obtaining a basic structure for the speaker device 20.

In this way, the yoke 22 consists of one disc-like member, while the center pole 32 consists of an upper portion and a lower portion, with the upper portion being the protruding portion 3a₂ and the lower portion being the center pole lower portion 3b₂ having an outer diameter smaller than that of the protruding portion 3a₂, thereby forming an integral structure. Therefore, since the yoke 22 and the center pole 32 of the speaker device 20 of the present embodiment are two mutually independent members each having a simple shape and combined together in a manner as shown, they can be easily processed in a cutting treatment and ensure an easy operation of installing the short ring SR2.

Next, description will be given with reference to FIGS. 3A and 3B. In fact, FIGS. 3A and 3B are cross sectional views showing a second embodiment of the present invention. Magnetic circuits of speaker devices 30 and 40 shown in these drawings differ from the magnetic circuits of the speaker devices 10 and 20 shown in FIGS. 2A and 2B in that the top of the center pole of each speaker device has an extended portion. Further, the periphery of each extended portion is covered by a short ring, and center poles 33 and 34 including yokes 23 and 24 are formed of two pieces of different members (two parts), as will be successively described below.

The magnetic circuit of the speaker device 30 shown in FIG. 3A has a center pole lower portion 3b₃ integrally formed with the yoke 23, while an independent disc-like member 3a₃ is mounted on the center pole lower portion 3b₃. An extended portion 3c₃ is integrally formed with the disc-like member 3a₃ and located over the disc-like member 3a₃. Such an extended portion 3c₃ has a diameter smaller than that of the disc-like member 3a₃, and is covered by a short ring SR4. The short ring SR4 is disposed on the side surface of the extended portion 3c₃, and if necessary, the top surface of the extended portion 3c₃ can be completely covered by the short ring SR4. Similarly, the outer periphery surface of the center pole lower portion 3b₃ is covered by a short ring SR3 in the same manner as shown in FIG. 2A.

According to the present embodiment, when the center pole 33 of the speaker device 30 is assembled, it is required to provide the center pole lower portion 3b₃ integrally formed with the yoke 23, and to attach a short ring SR3 to the surface of the lower portion 3b₃ of the center pole 33. Subsequently, a disc-like member 3a₃ having an extended portion 3c₃ covered by the short ring SR4 is mounted on the center pole lower portion 3b₃, thereby forming the center pole 33 shown in FIG. 3A. Afterwards, a voice coil bobbin 8 carrying a voice coil 7 is disposed in a magnetic gap 6 formed between the outer periphery of the disc-like member 3a₃ and the inner edge of the top plate 5, thus forming a basic structure for the speaker device 30.

In this manner, the center pole lower portion 3b₃ integrally formed with the yoke 23 has a simple configuration, the independent disc-like member 3a₃ has almost the same thickness as that of the plate 5 and has as its top portion the extended portion 3c₃ having a smaller diameter. In this way, since the center pole 33 of the speaker device 30 of the present embodiment are composed of two mutually independent members each having a simple shape, they can be easily processed in a cutting treatment, thus ensuring an easy operation of installing the short rings SR3 and SR4.

Next, description will be given to explain the speaker device 40 shown in FIG. 3B. As shown, a center pole 34 of a magnetic circuit of the speaker device 40 has a protruding portion 3a₄ facing a magnetic gap 6, and has, under this protruding portion, a center pole lower portion 3b₄ having a diameter smaller than that of the protruding portion 3a₄ and covered by a short ring SR5. Further, there is formed on the protruding portion 3a₄ an extended portion 3c₄ having a diameter smaller than that of the protruding portion 3a₄ and covered by a short ring SR6. In other words, according to the present embodiment of the present invention, the center pole 34 is composed of the protruding portion 3a₄, the center pole lower portion 3b₄, and the extended portion 3c₄, which are made of an identical material and have been formed into an integral body.

Further, according to the present embodiment, the speaker device 40 is formed in a manner such that the yoke 24 and the center pole 34 are made of completely different materials and that when they are assembled together, the protruding portion 3a₄ serves as a boundary to attach the short ring SR5 to the outer periphery surface of the center pole lower portion 3b₄ and attach the short ring SR6 to the top and side surfaces of the extended portion 3c₄. Subsequently, the center pole lower portion 3b₄ is bonded to the center of the disc-like yoke 24, thereby forming the center pole 34 shown in FIG. 3B. Finally, a voice coil bobbin 8 carrying a voice coil 7 is disposed in a magnetic gap 6 formed between the outer periphery surface of the extended portion 3a₄ and the inner edge of the top plate 5, thus forming the basic structure for the speaker device 40.

Here, the yoke 24 is made of one piece of a disc-like material having a simple configuration, while the center pole 34 comprises a center pole lower portion 3b₄, a protruding portion 3a₄ having a diameter larger than that of the center pole lower portion 3b₄, and an extended portion 3c₄ having a diameter smaller than that of the protruding portion 3a₄, which are all simple in their shapes. Therefore, in the present embodiment, a necessary operation is only to attach the short rings SR5 and SR6 to the upper and lower portions of the center pole 34 having relatively simple configurations, followed by bonding the center pole lower portion 3b₄ to the center of the disc-like yoke 24. In this way, since the related members are all simple in their configurations, the center pole 34 of the speaker device 40 of the present embodiment is easy to be processed in a cutting treatment, thus making it easy to perform an operation for installing the short rings SR5 and SR6.

Next, description will be given with reference to FIGS. 4A and 4B. In fact, FIGS. 4A and 4B are cross sectional views showing a third embodiment of the present invention. As shown, magnetic circuits of speaker devices 50 and 60 shown in these drawings each includes an extension member on the top of center pole. Further, the center poles 35 and 36 including yokes 25 and 26 of the speaker devices 50 and 60 are formed by three pieces of different members (three parts), as will be successively described below.

The magnetic circuit of the speaker device 50 shown in FIG. 4A is so formed that its center pole 35 comprises a disc-like member 3a₅ facing a magnetic gap 6, a center pole lower portion 3d₅ integrally formed with a yoke 2, and an extension member 3c₅ independent from the disc-like member 3a₅ and mounted on the disc-like member 3a₅. Here, each of the extension member 3c₅ and the center pole lower portion 3b₅ has a diameter smaller than that of the disc-like member 3a₅. Then, a short ring SR7 is attached to the outer periphery surface of the center pole lower portion 3b₅ and a short ring SR5 is attached to the outer periphery surface of the extension member 3c₅. On the other hand, if necessary, the short ring SR8 can also be formed in a manner such that it can be attached to the top surface of the extension member 3c₅.

According to the present embodiment, when installing the center pole 35 of the speaker device 50, it is required to form the center pole lower portion 3b₅ in an integral structure with the yoke 25, followed by attaching the short ring SR7 to the side face, and if necessary, also to the top surface of the center pole lower portion 3b₅. Then, the disc-like member 3a₅ is mounted on the center pole lower portion 3b₅, while an extension member 3c₅ carrying on its surface the short ring SR5 is mounted on the disc-like member 3a₅, thereby forming the center pole 35 of the speaker device 50. On the other hand, it is also possible for the short ring SR8 to be attached to the surface of the extension member 3c₅ after the extension member 3c₅ is mounted in the aforementioned manner. Moreover, if necessary, the short ring SR5 can also be so shaped that it can be attached to the top surface of the extension member 3c₅. Finally, a voice coil bobbin 8 carrying a voice coil 7 is disposed in a magnetic gap 6 formed between the outer periphery surface of the disc-like member 3a₅ and the inner edge of the top plate 5, thus forming a basic structure for the speaker device 50.

In this way, the center pole 35 comprises three pieces of different members including the disc-like member 3a₅, the center pole lower portion 3b₅ integrally formed with the yoke 25, and the disc-like extension member 3c₅. Therefore, since the center pole 35 of the speaker device 50 according to the present embodiment of the present invention is simple in its configuration, it is easy to be processed in a cutting treatment, thus making it easy to perform an operation for installing the short rings SR7 and SR8.

On the other hand, the magnetic circuit of the speaker device 60 shown in FIG. 4B is so formed that it consists of a yoke 26 and a center pole 36 which are completely separated from each other until being assembled together. The center pole 36 has on its upper side a protruding portion 3a₆ facing a magnetic gap 6, and a center pole lower portion 3b₆ integrally formed with the protruding portion 3a₆ and having a diameter smaller than that of the protruding portion 3a₆. Further, over the protruding portion 3a₆ there is provided an extension member 3c₆ not integrally formed with the protruding portion 3a₆ and having a diameter smaller than that of the protruding portion 3a₆.

According to the present embodiment, when installing the center pole 36 of the speaker device 60, it is required to bond the center pole lower portion 3b₅ carrying on the outer surface thereof a short ring SR7 to the center of a disc-like yoke 2, followed by mounting on the center pole lower portion 3b₅ an extension member 3c₅ carrying on its outer periphery a short ring SR10, thereby forming the center pole 36 of the speaker device 60. Moreover, if necessary, the short ring SR10 can also be attached to the surface of the extension member 3c₆ after it is mounted in a manner shown in FIG. 4B. Finally, a voice coil bobbin 8 carrying a voice coil 7 is disposed in a magnetic gap 6 formed between the outer periphery of the disc-like member 3a₆ and the inner edge of the top plate 5, thus forming a basic structure for the speaker device 60.

In this way, the center pole 36 comprises three pieces of different members including the protruding portion 3a₆, the center pole lower portion 3b₆ integrally formed with the protruding portion 3a₆, and the extension member 3a₆ mounted on the protruding portion 3a₆, which are all mounted on the disc-like yoke 2. Therefore, since the center pole 36 of the speaker device 60 according to the present embodiment of the present invention is simple in its configuration, it is easy to be processed in a cutting treatment, thus making it easy to perform an operation for installing the short rings SR9 and SR10.

As shown in FIG. 2A, FIG. 3A, and FIG. 4A representing the embodiments of the present invention, the short rings SR1, SR3, and SR7 attached to the outer periphery surfaces of the center pole lower portions 3b₁, 3b₃ and 3b₅ integrally formed with the yokes 21, 22, and 23 are also in contact with the top surfaces of the center pole lower portions by forming the positioning end portions in contact with these top surfaces. However, the present invention should not be limited by such specific examples. In fact, it is also possible for the short rings to have cap-like shape so as to cover up the entire top surface of each of the center pole lower portions 3b₁, 3b₃, and 3b₅. In this way, it is possible to correctly position these short rings and allow the short rings to cover up entire top surfaces of the center pole lower portions 3b₁, 3b₃, and 3b₅. Therefore, it is possible to remarkably reduce an unfavorable influence on the DC magnetic flux, which influence is usually brought about due to an AC magnetic flux caused by the vibration of voice coil.

Although the short rings used in the embodiments of the present invention are formed by non-magnetic material such as copper and aluminum or the like, the present invention should not be limited by this. In fact, it is also possible to use other sorts of non-magnetic metals provided that they are capable of reducing an unfavorable influence on DC magnetic flux.

As described above, since each center pole containing a yoke is a two-piece structure or a three-piece structure, the speaker magnetic circuits, the methods of manufacturing the speaker magnetic circuits, and the speaker devices containing the speaker magnetic circuits make it easy to conduct an operation of installing short rings, thereby making it possible to reduce the cost of assembling.

Moreover, since various parts are relatively simple in their configurations, they are easy to be processed in a cutting treatment. Therefore, it is possible to reduce the cost of parts and make an assembling operation extremely simple. As a result, it becomes possible to greatly simplify the manufacturing process by reducing the steps of complex cutting treatment, thereby reducing the manufacturing cost.

Furthermore, by virtual of the attached short rings, it is possible to realize speaker magnetic circuits capable of removing any unfavorable influence of AC magnetic flux caused by the vibration of voice coil. Besides, since the short rings attached to the top surfaces of center pole lower portions each has a positioning end portion to contact the top surface of each center pole lower portion, it is allowed to attach the short rings in their correct positions.

While there has been described what are at present considered to be preferred embodiments of the present invention, it will be understood that various modifications may be made thereto, and it is intended that the appended claims cover all such modifications as fall within the true spirit and scope of the invention.

1. A magnetic circuit for use in a speaker, said magnetic circuit comprising:
a center pole;
a yoke on the center of which the center pole is formed;
a magnet disposed on the yoke close to the perimeter thereof;
a plate disposed on the magnet; and
a magnetic gap formed between the inner edge of the plate and the outer periphery of the center pole for receiving a voice coil,
wherein the center pole is formed by mounting an independent disc-like member having a diameter larger than that of a center pole lower portion on the center pole lower portion integrally formed with the yoke,
wherein the magnetic gap is formed by virtue of the periphery surface of the disc-like member, while a non-magnetic short ring is attached to the surface of the center pole lower portion.

2. The magnetic circuit for use in a speaker according to claim 1, wherein the short ring has a positioning end portion to get in contact with the top surface of the center pole lower portion.

3. The magnetic circuit for use in a speaker according to claim 1,
wherein the short ring is a first short ring,
wherein an extension portion integrally formed with and on the disc-like member has a diameter smaller than that of the disc-like member,
wherein a second short ring is attached to the surface of the extension portion.

4. The magnetic circuit for use in a speaker according to claim 1,
wherein the short ring is a first short ring,
wherein an extension member mounted on the disc-like member and not integrally formed with the disc-like member has a diameter smaller than that of the disc-like member,
wherein a second short ring is attached to the surface of the extension member.

5. The magnetic circuit for use in a speaker according to claim 3, wherein the second short ring is attached to the side surface and the top surface of the extension portion or the extension member.

6. A magnetic circuit for use in a speaker, said magnetic circuit comprising:
a center pole;
a yoke on the center of which the center pole is formed;
a magnet disposed on the yoke close to the perimeter thereof;
a plate disposed on the magnet; and
a magnetic gap formed between the inner edge of the plate and the outer periphery of the center pole for receiving a voice coil,
where the center pole is formed by mounting the center pole lower portion not integrally formed with the yoke on the yoke, and including a protruding portion integrally formed with the center pole lower portion and having a diameter larger than that of the center pole lower portion,
wherein the magnetic gap is formed by virtue of the periphery surface of the protruding portion, while a non-magnetic short ring is attached to the surface of the center pole lower portion.

7. The magnetic circuit for use in a speaker according to claim 6, wherein the short ring is a first short ring,
wherein an extension portion integrally formed with and on the protruding portion has a diameter smaller than that of the protruding portion,
wherein a second short ring is attached to the surface of the extension portion.

8. The magnetic circuit for use in a speaker according to claim 6, wherein the short ring is a first short ring,
wherein an extension member not integrally formed with the protruding portion and mounted on the protruding portion has a diameter smaller than that of the protruding portion,
wherein a second short ring is attached to the surface of the extension member.

9. The magnetic circuit for use in a speaker according to claim 7, wherein the second short ring is attached to the side surface and the top surface of the extension portion or the extension member.

10. A speaker device having a magnetic circuit recited in claim 1, wherein a voice coil bobbin on which a voice coil has been arranged is disposed within the magnetic gap.

11. A method of manufacturing a speaker magnetic circuit including: a center pole; a yoke on the center of which the center pole is formed; a magnet disposed on the yoke close to the perimeter thereof; a plate disposed on the magnet; and a magnetic gap formed between the inner edge of the plate and the outer periphery of the center pole for receiving a voice coil,
wherein after a non-magnetic short ring is attached to the surface of a center pole lower portion integrally formed with the yoke, a disc-like member having a diameter larger than that of the center pole lower portion is mounted on the center pole lower portion, thereby forming the center pole by virtue of the center pole lower portion and the disc-like member, and thus forming the magnetic gap by virtue of the periphery surface of the disc-like member.

12. A method of manufacturing a speaker magnetic circuit including: a center pole; a yoke on the center of which the center pole is formed; a magnet disposed on the yoke close to the perimeter thereof; a plate disposed on the magnet; and a magnetic gap formed between the inner edge of the plate and the outer periphery of the center pole for receiving a voice coil, wherein the center pole is formed by including a center pole lower portion and a protruding portion having a diameter larger than that of the center pole lower portion and integrally formed with the center pole lower portion,
wherein after a non-magnetic short ring is attached to the surface of the center pole lower portion, the center pole is mounted on the yoke which is not integrally formed with the center pole, and the magnetic gap is formed by virtue of the periphery surface of the protruding portion.

13. The magnetic circuit for use in a speaker according to claim 2,
wherein the short ring is a first short ring,
wherein an extension portion integrally formed with and on the disc-like member has a diameter smaller than that of the disc-like member,
wherein a second short ring is attached to the surface of the extension portion.

14. The magnetic circuit for use in a speaker according to claim 2,
wherein the short ring is a first short ring,
wherein an extension member mounted on the disc-like member and not integrally formed with the disc-like member has a diameter smaller than that of the disc-like member,
wherein a second short ring is attached to the surface of the extension member.

15. The magnetic circuit for use in a speaker according to claim 4, wherein the second short ring is attached to the side surface and the top surface of the extension portion or the extension member.

16. The magnetic circuit for use in a speaker according to claim 13, wherein the second short ring is attached to the side surface and the top surface of the extension portion or the extension member.

17. The magnetic circuit for use in a speaker according to claim 14, wherein the second short ring is attached to the side surface and the top surface of the extension portion or the extension member.

18. The magnetic circuit for use in a speaker according to claim 8, wherein the second short ring is attached to the side surface and the top surface of the extension portion or the extension member.

19. A speaker device having a magnetic circuit recited in claim 6, wherein a voice coil bobbin on which a voice coil has been arranged is disposed within the magnetic gap.
